(19) United States
(12) Patent Application Publication
(10) Pub. No.: US 2013/0051499 A1
(43) Pub. Date: Feb. 28, 2013

(54) METHOD AND DEVICE FOR IMPROVING ENSEMBLE AUTO SEARCHING EFFICIENCY

(71) Applicant: Shih-Wei Chang, New Taipei City (TW)

(72) Inventor: Shih-Wei Chang, New Taipei City (TW)

(73) Assignee: KEYSTONE SEMICONDUCTOR CORP., Hsinchu (TW)

(21) Appl. No.: 13/330,605

(22) Filed: Dec. 19, 2011

(30) Foreign Application Priority Data
Aug. 31, 2011 (TW) 100131325

(51) Int. Cl. H04L 27/06

(52) U.S. Cl. 375/340

(57) ABSTRACT

A method and a device for improving ensemble auto searching efficiency are provided. In this method, a first digital audio broadcasting transmitted signal is received, and a time interval between null symbols of adjacent ones of multiple continuous transmitted frames in the first digital audio broadcasting transmitted signal is calculated. If the time interval fits a preset transmitted frame time duration, it is then determined that a first channel corresponding to the first digital audio broadcasting transmitted signal is a preliminarily identified digital audio broadcasting channel. A first phase reference symbol of the first digital audio broadcasting transmitted signal is then detected, and a first correlation value between the first phase reference symbol and a preset phase reference symbol is calculated. If the first correlation value is greater than or equal to a threshold, it is then determined that the first channel is a valid digital audio broadcasting channel.

### CROSS-REFERENCE TO RELATED APPLICATION

This application claims the priority benefit of Taiwan application serial no. 100131325, filed on Aug. 31, 2011. The entirety of the above-mentioned patent application is hereby incorporated by reference herein and made a part of this specification.

### BACKGROUND OF THE INVENTION

1. Field of the Invention

The present invention relates to a device and method for improving ensemble auto searching efficiency, and more particularly, to a device and method for improving ensemble auto searching efficiency which is adapted for digital audio broadcasting (DAB).

2. Description of Related Art

The ensemble auto searching mechanism used by current digital audio broadcasting (DAB) is subject to limitation of synchronization mechanism or signal receiving condition (e.g. noise interference), which can lead to the misjudgement of an ensemble. As a result, the DAB often wastes time in searching ensemble information that even does not exist, which slows down the ensemble auto searching and thus wastes time and power of the corresponding electronic device. What is desired, therefore, is to reduce the time waste due to misjudgement during ensemble auto searching, thus effectively reducing the time for ensemble auto searching.

### SUMMARY OF THE INVENTION

Accordingly, the present invention is directed to a device and method for improving ensemble auto searching efficiency which can reduce waste of time due to misjudgment during ensemble auto searching.

The prevent invention provides a method for improving ensemble auto searching efficiency, adapted for ensemble auto searching of a digital audio broadcasting (DAB) system. In this method, a first digital audio broadcasting transmitted signal is received, and a time interval between null symbols of adjacent ones of multiple continuous transmitted frames in the first digital audio broadcasting transmitted signal is calculated. If the time interval fits a preset transmitted frame time duration, it is then determined that a first channel corresponding to the first digital audio broadcasting transmitted signal is a preliminarily identified digital audio broadcasting channel. A first phase reference symbol (PRS) of the first digital audio broadcasting transmitted signal is then detected, and a first correlation value between the first phase reference symbol and a preset phase reference symbol is calculated. If the first correlation value is greater than or equal to a threshold, it is then determined that the first channel is a valid digital audio broadcasting channel.

In one embodiment, the method for improving ensemble auto searching efficiency further comprises, if the time interval does not fit the preset transmitted frame time duration, determining the first channel corresponding to the first digital audio broadcasting transmitted signal to be an invalid digital audio broadcasting channel; and proceeding to a next channel for execution of the ensemble auto searching.

In one embodiment, if the correlation value between the first phase reference symbol and the preset phase reference symbol calculated with respect to each carrier frequency offset is different, the highest correlation value is selected as the first correlation value.

In one embodiment, the method for improving ensemble auto searching efficiency further comprises using the first correlation value for frequency synchronization and phase synchronization of the ensemble auto searching.

In one embodiment, the method for improving ensemble auto searching efficiency further comprises, if the first correlation value is less than the threshold, determining the first channel corresponding to the first digital audio broadcasting transmitted signal to be an invalid digital audio broadcasting channel; and proceeding to a next channel for execution of the ensemble auto searching.

In one embodiment, the method for improving ensemble auto searching efficiency further comprises collecting digital content service information in the first channel after determining the first channel corresponding to the first digital audio broadcasting transmitted signal to be a valid digital audio broadcasting channel.

In one embodiment, when the collected amount of digital content service information in the first channel has reached a desired amount, the digital content service information is stored.

In one embodiment, when the collected amount of digital content service information in the first channel does not reach a desired amount within a predetermined time limit, the method controls the digital audio broadcasting system to proceed to a next channel for execution of the ensemble auto searching.

In one embodiment, the method for improving ensemble auto searching efficiency further comprises obtaining a mapping value by mapping the first correlation value to signal quality criteria and determining the current signal quality of the first channel based on the mapping value.

The present invention is also directed to a device for improving ensemble auto searching efficiency, adapted for ensemble auto searching of a digital audio broadcasting system. The device includes a transceiver module, a storage unit and a control module. The transceiver module receives a first digital audio broadcasting transmitted signal. The storage unit provides a storage space for storing a preset phase reference symbol. The control module is coupled to the transceiver module and the storage unit for calculating a time interval between null symbols of adjacent ones of multiple continuous transmitted frames in the first digital audio broadcasting transmitted signal. If the time interval fits a preset transmitted frame time duration, the control module determines a first channel corresponding to the first digital audio broadcasting transmitted signal to be a preliminarily identified digital audio broadcasting channel. The control module then detects a first phase reference symbol of the first digital audio broadcasting transmitted signal, and calculates a first correlation value between the first phase reference symbol and the preset phase reference symbol. If the first correlation value is greater than or equal to a threshold, the control module determines the first channel to be a valid digital audio broadcasting channel.

In view of the foregoing, the prevent invention provides a method and device for improving ensemble auto searching efficiency. In order to improve the ensemble searching efficiency, the method and device takes advantage of characteristics of the phase reference symbol in the digital audio broadcasting transmitted signal to effectively avoid waste of time due to misjudgement during ensemble auto searching, thus reducing the time for ensemble auto searching.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a frame structure of a digital audio broadcasting (DAB) transmitted signal.

FIG. 2A is a comparison table of various parameters of the phase reference symbol of a DAB transmitted signal in the transmission mode I.

FIG. 2B is a comparison table of various parameters of the phase reference symbol of a DAB transmitted signal in the transmission mode II.

FIG. 2C is a comparison table of various parameters of the phase reference symbol of a DAB transmitted signal in the transmission mode III.

FIG. 2D is a comparison table of various parameters of the phase reference symbol of a DAB transmitted signal in the transmission mode IV.

FIG. 2E is a time-frequency-phase parameter h comparison table of the phase reference symbol of a DAB transmitted signal.

FIG. 3 is a functional block diagram of a device for improving ensemble auto searching efficiency according to one embodiment of the present invention.

FIG. 4A is a flowchart of a method for improving ensemble auto searching efficiency according to one embodiment of the present invention.

FIG. 4B is a flowchart of a method for improving ensemble auto searching efficiency according to another embodiment of the present invention.

FIG. 5A illustrates the calculation results of the correlation value of the phase reference symbol according to one embodiment of the present invention.

FIG. 5B illustrates the calculation results of the correlation value of the phase reference symbol according to another embodiment of the present invention.

### DESCRIPTION OF THE EMBODIMENTS

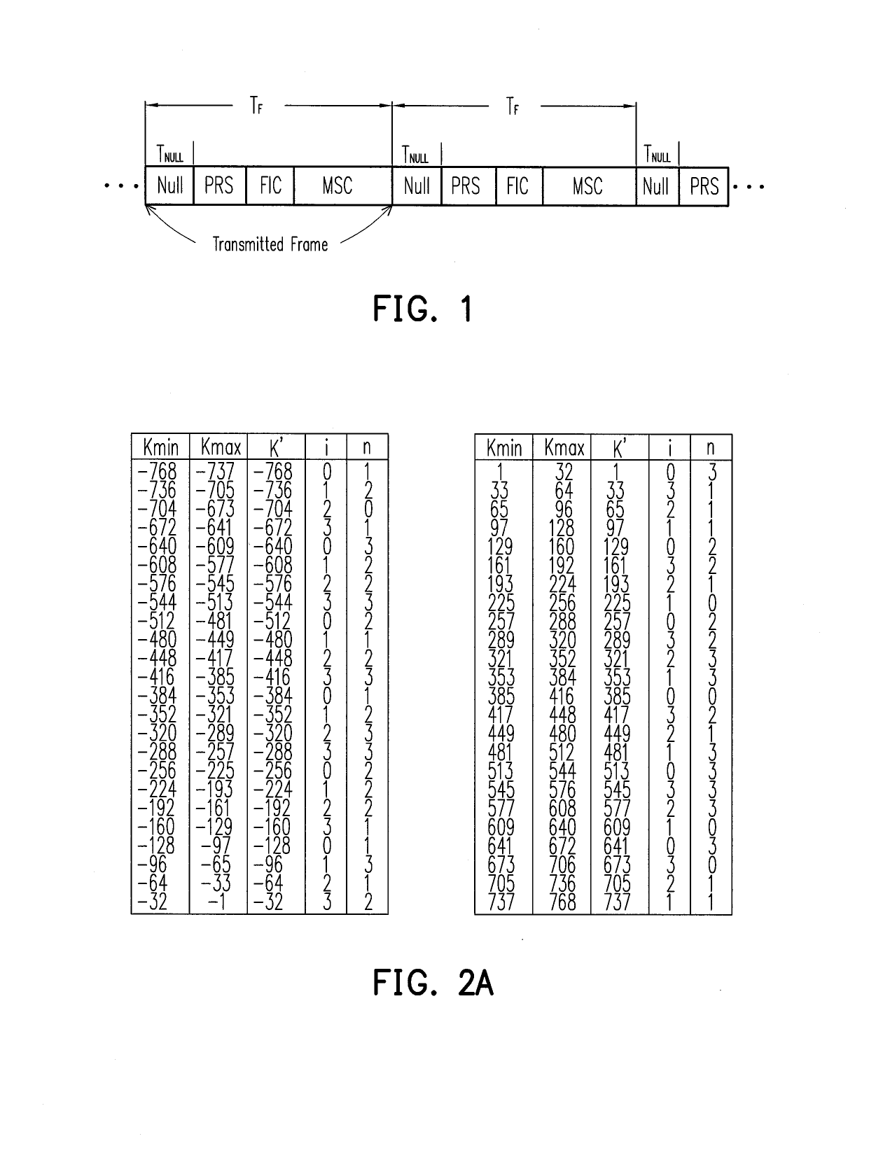

FIG. 1 illustrates a frame structure of a digital audio broadcasting (DAB) transmitted signal. The DAB transmitted signal includes a plurality of continuous transmitted frames, each including a null symbol (NULL), a phase reference symbol (PRS), a fast information channel (FIC), and a main service channel (MSC). The null symbol carries no signal and mainly functions for frame synchronization which is used to preliminarily detect whether there is possibly a DAB channel. The phase reference symbol has synchronization information such as frequency and phase. The fast information channel carries information such as channel and ensemble content. The main service channel carries digital content of program or service. T_{F} represents the time duration between the null symbols of adjacent transmitted frame, and T_{NULL} represents the time duration of a single null symbol. The time duration of T_{F} and T_{NULL} in Table 1 below is defined in the DAB system specification established by European telecommunications standards institute (ETSI).

TABLE 1
Time Duration of Transmitted Frame in
Different Transmission Modes (Unit: ms)

| | Transmission | Transmission | Transmission | Transmission |
|---|---|---|---|---|
| Time Duration | Mode I | Mode II | Mode III | Mode IV |
| T_{NULL} | 1.297 ms | 0.324 ms | 0.168 ms | 0.648 ms |
| T_{F} | 96 ms | 24 ms | 24 ms | 48 ms |

The phase reference symbol is an orthogonal frequency division multiplex (OFDM) symbol which is defined as follows:

$${z}_{1 , k} = \{ \begin{matrix}{e}^{j {ϕ}_{k}} & for - \frac{K}{2} \leq k < 0 and 0 < k \leq \frac{K}{2} \\ 0 & for k = 0\end{matrix} \\ {ϕ}_{k} = \frac{π}{2} ( {h}_{i , k - {k}^{′}} + n )$$

In the above equations, z_{1,k} represents the complex differential quadrature reference phase shift keying symbol (Complex D-QPSK Symbol) of the phase reference symbol corresponding to the k^{th} carrier, where K is the number of the transmission carriers, and the values of h_{i,k-k′}, i, k′, n depend upon the frequency and phase, the relationship of which is defined in Table 39-43 of DAB specification EN300-401 established by ETSI.

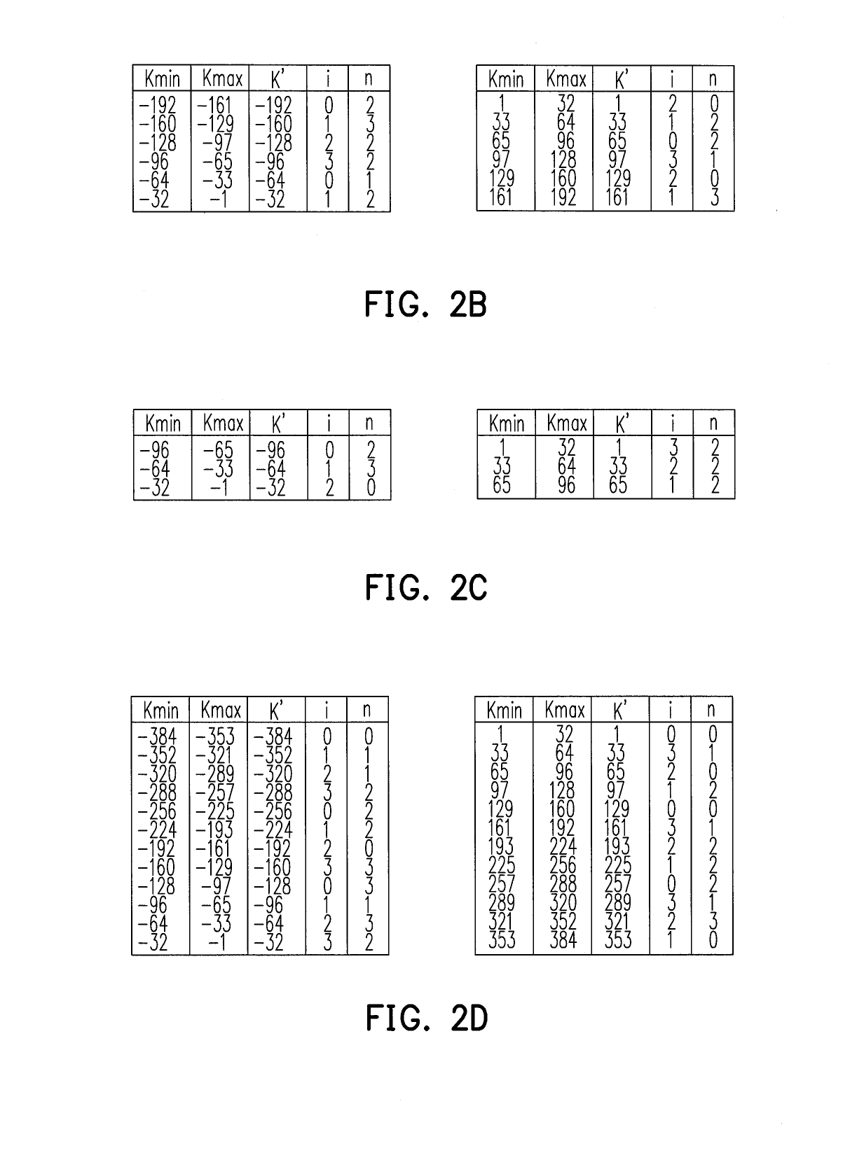

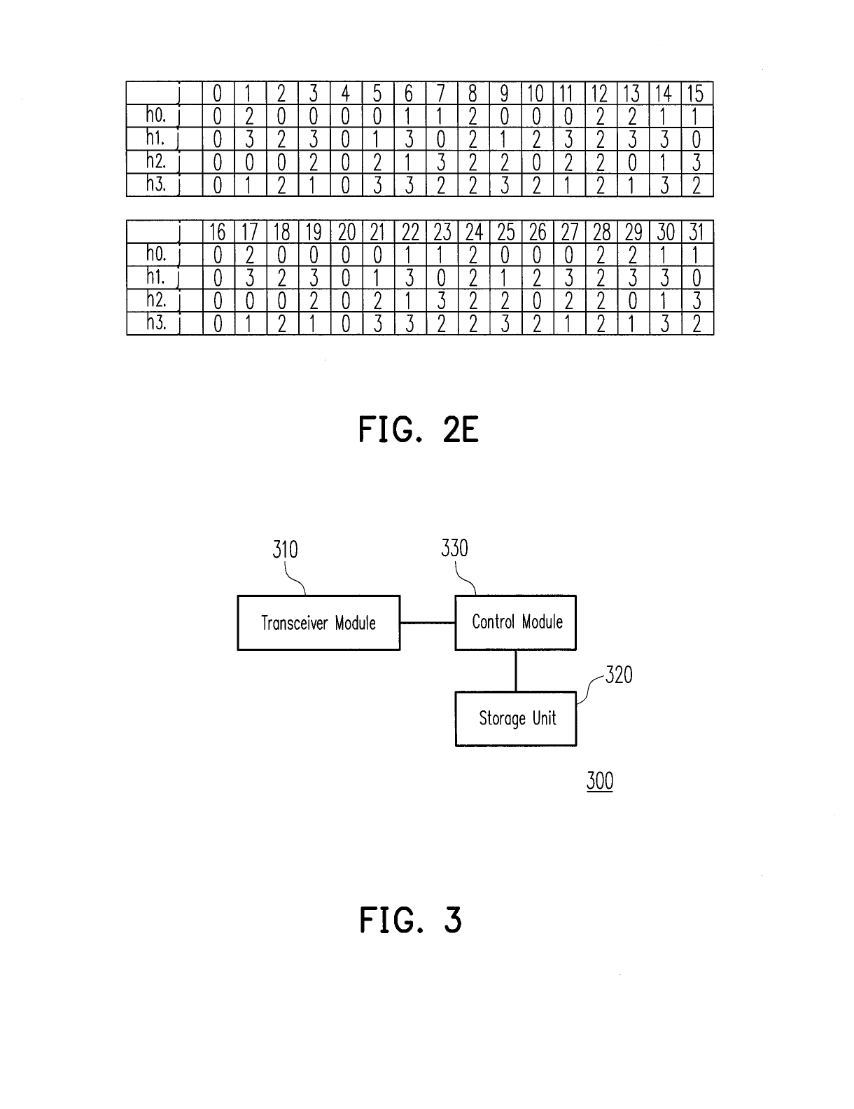

FIG. 2A shows the Table 39 of the DAB specification EN300-401, which is a comparison table of various parameters of the phase reference symbol of a DAB transmitted signal in the transmission mode I. FIG. 2B shows the Table 40 of the DAB specification EN300-401, which is a comparison table of various parameters of the phase reference symbol of a DAB transmitted signal in the transmission mode II. FIG. 2C shows the Table 41 of the DAB specification EN300-401, which is a comparison table of various parameters of the phase reference symbol of a DAB transmitted signal in the transmission mode III. FIG. 2D shows the Table 42 of the DAB specification EN300-401, which is a comparison table of various parameters of the phase reference symbol of a DAB transmitted signal in the transmission mode IV. FIG. 2E shows the Table 43 of the DAB specification EN300-401, which is a time-frequency-phase parameter h comparison table of the phase reference symbol of a DAB transmitted signal, where j=k-k′.

FIG. 3 is a functional block diagram of a device for improving ensemble auto searching efficiency according to one embodiment of the present invention. The device 300 is adapted for ensemble auto searching of a DAB system that includes a transceiver module 310, a storage unit 320, and a control module 330. The transceiver module 310 is an antenna unit (e.g. an antenna circuit element) for receiving the DAB transmitted signal. The storage unit 320 may be a hard disk, a floppy disk, a flash memory or another conventional storage device that can provide a storage space. The control module 330 is coupled to the transceiver module 310 and the storage unit 320. The control module 330 is a functional block implemented by hardware and/or software and/or firmware. The hardware may include a hardware device having a computing function, such as, a central processing unit, a chipset, a microprocessor or any combination thereof. The software may be an operating system, driver, or the like.

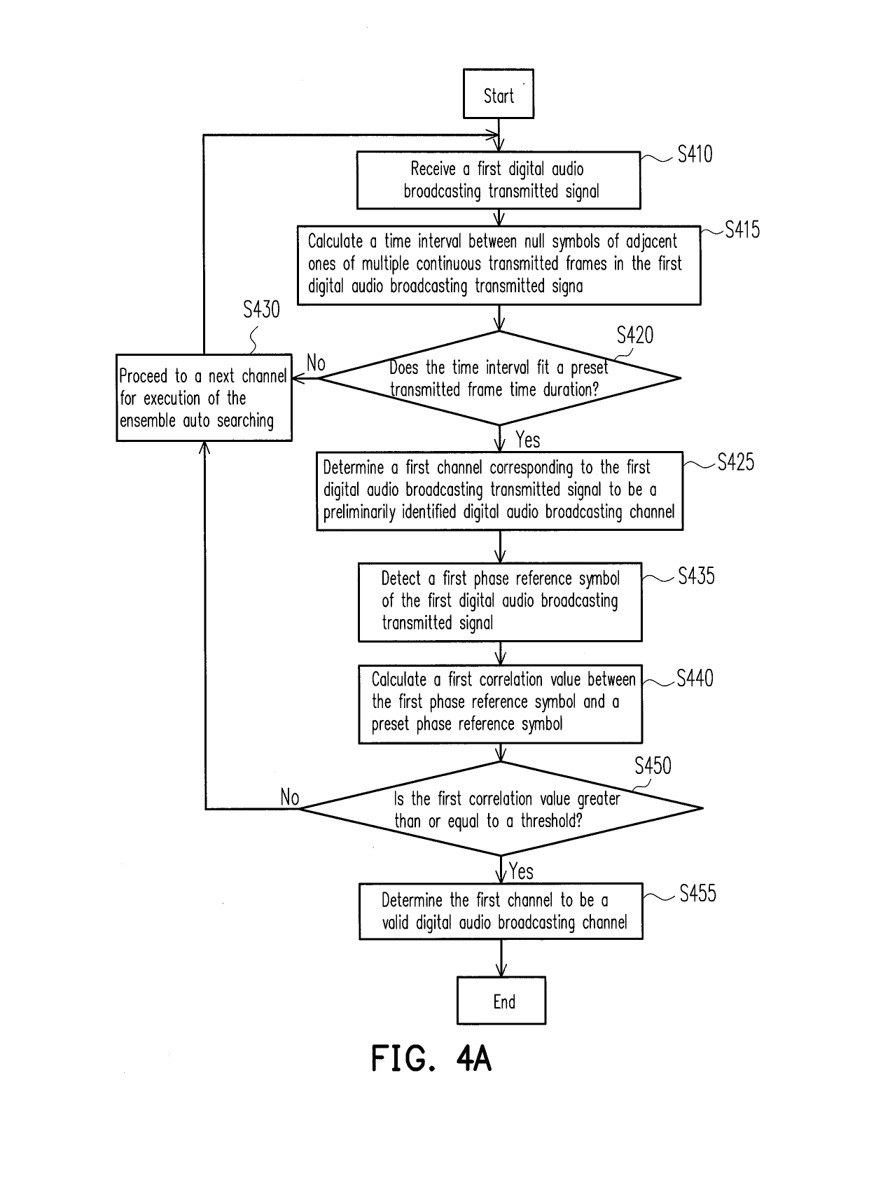

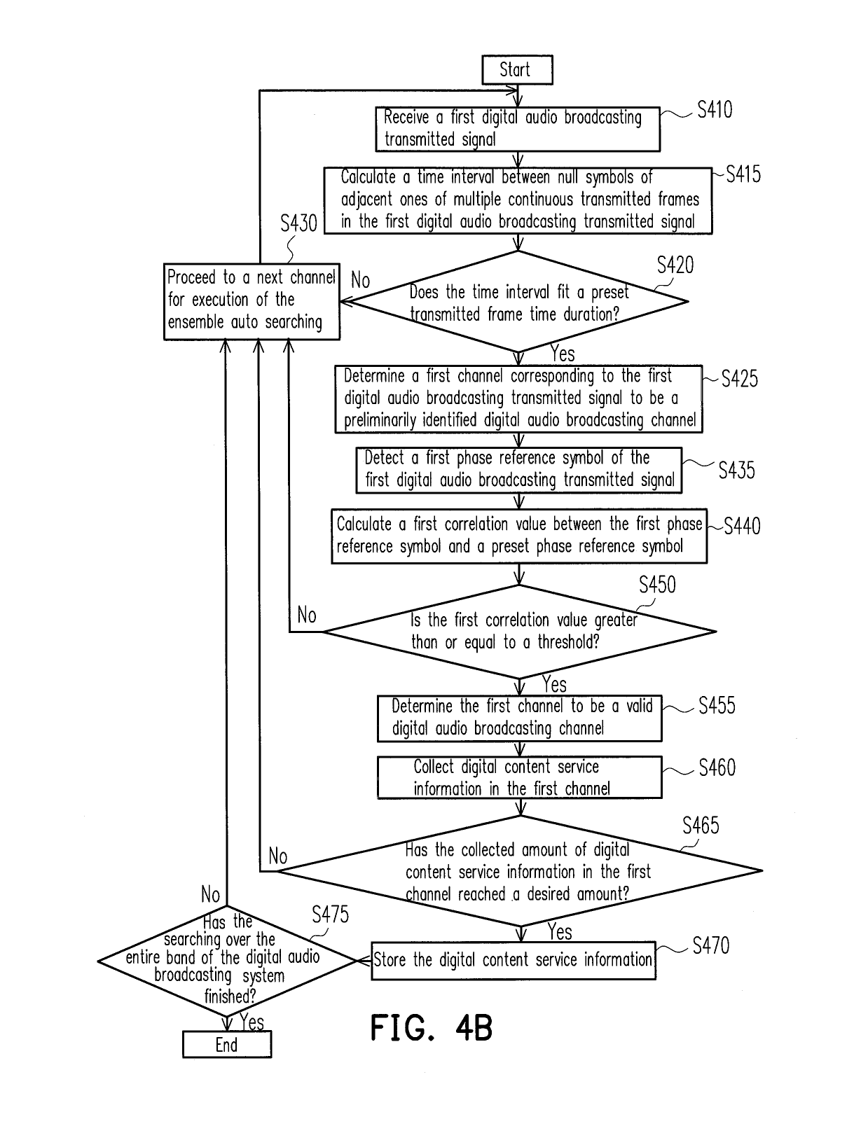

FIG. 4A is a flowchart of a method for improving ensemble auto searching efficiency according to one embodiment of the present invention. Referring to FIG. 3 and FIG. 4A, firstly, the control module 330 sets and initializes various parameters of ensemble auto searching of the DAB system, such as radio frequency (RF), baseband frequency. The transceiver module 310 then receives a first DAB transmitted signal (step S410). The control module 330 then calculates a time interval between the null symbols of adjacent ones of multiple continuous transmitted frames of the first DAB transmitted signal (step S415). The control module 330 determines whether the time interval between adjacent null symbols fits a preset transmitted frame time duration (step S420). The preset transmitted frame time duration may be stored in the storage unit 320 in advance. The preset transmitted frame time duration may be T_{F} shown in FIG. 1, and its specified values in various transmission modes are listed in Table 1.

The DAB systems in the same area adopt the fixed and same transmission mode. Therefore, the control module 330 determines whether a first channel corresponding to the current first DAB transmitted signal is a possible DAB channel by determining whether the time interval between adjacent null symbols fits the preset transmitted frame time duration. In other words, if the determining result of step S420 is yes, it is then preliminarily determined that the first channel corresponding to the first DAB transmitted signal is a preliminarily identified DAB channel (step S425). Otherwise, i.e. if the time interval does not fit the preset transmitted frame time duration, the control module 330 determines that the first channel corresponding to the first DAB transmitted signal is an invalid DAB channel and then proceeds to a next channel for execution of ensemble auto searching (step S430).

However, it may be insufficient if only the preliminary identification is performed. If whether it is a valid DAB channel is determined only by such a mechanism of determining whether the time interval between the null symbols fits the preset transmitted frame time duration, then the setting mechanism will affect the accuracy of determination when setting the preset transmitted frame time duration. For example, when the DAB systems in this area use the transmission mode IV in which TF specified in the specification is 48 ms, if the upper and lower limits of the preset transmitted frame time duration are too loosely set, for example, are set as 48 ms±10 ms, this may easily result in many actually invalid DAB channels being searched. On the contrary, if the time duration is set too strictly, for example, it is set such that only a channel that has a time interval of 48 ms as specified in the transmission mode IV in the specification can be considered as a valid DAB channel, the searching may miss some valid DAB channels due to poor signal. Therefore, a further screening mechanism is needed to avoid the problems existing in setting the preset transmitted frame time duration.

This further screening mechanism may be implemented by taking advantage of the phase reference symbol. Subsequent to step S425 where it is preliminarily determined that the first channel corresponding to the first DAB transmitted signal is a preliminary identified DAB channel, the control module 330 detects a first phase reference symbol of the first DAB transmitted signal (step S435) and then calculates a first correlation value between the first phase reference symbol and a preset phase reference symbol (step S440). The preset phase reference symbol may be stored in the storage unit 320. The phase reference symbols of the DAB systems in the same area are the same. The control module 330 also uses the first correlation value for frequency and phase synchronization mechanism of the ensemble auto searching.

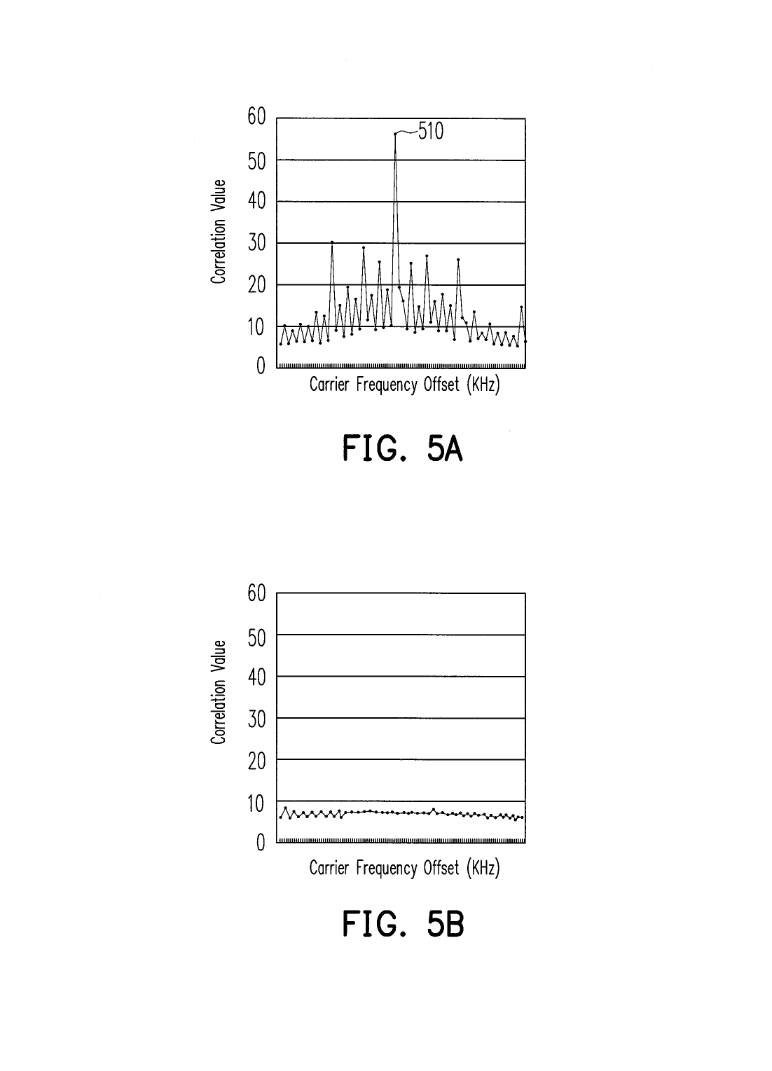

The control module 330 then determines whether the calculated first correlation value is greater than or equal to a threshold (step S450). The threshold may be stored in the storage unit 320, which may be defined by a user or a default value. FIG. 5A illustrates the calculation results of the correlation value of the phase reference symbol according to one embodiment of the present invention. FIG. 5A shows the correlation value between the first phase reference symbol and the preset phase reference symbol with respect to each carrier frequency offset. If the calculated correlation value with respect to each carrier frequency offset is different, the highest correlation value is selected as the first correlation value. In other words, in the illustrated embodiment, the first correlation value between the first phase reference symbol and the preset reference symbol calculated by the control module 330 is the value 510 of FIG. 5A. If the threshold is 30 in this case, then the first correlation value is greater than the threshold 30 and the determination result of step S450 is yes. Because the first correlation value is greater than or equal to the threshold, the first channel is considered as a valid DAB channel (step S455).

FIG. 5B illustrates the calculation results of the correlation value of the phase reference symbol according to another embodiment of the present invention. In this embodiment, the input signal is a non-ensemble noise signal. As can be seen from FIG. 5B, the calculated correlation values with respect to the carrier frequency offset values are all very low, i.e. all are less than the threshold 30. That is, the determination result of step S450 is no. The control module 330 then determines that the first channel corresponding to the first DAB transmitted signal is an invalid DAB channel. The control module 330 thus proceeds to a next channel for execution of the ensemble auto searching (step S430).

FIG. 4B is a flowchart of a method for improving ensemble auto searching efficiency according to another embodiment of the present invention. Subsequent to step S455 of determining that the first channel is a valid DAB channel, the control module 330 collects digital content service information in the first channel, i.e. the fast information channel (FIC) and fast information block (FIB) (step S460). The control module 330 then determines whether the amount of the digital content service information in the first channel has reached a desired amount (step S465). This desired amount is determined on the basis of the content transmitted by the ensemble and is set at a receiving end. If the determination result is yes, i.e. the collected amount of digital content service information in the first channel has reached the desired amount, the control module 330 then stores the digital content service information into the storage unit 320 (step S470). If no, i.e. when the amount of digital content service information in the first channel collected by the control module 330 does not reach a desired amount within a predetermined time limit due to, for example, poor quality of a received signal or receiving of a false signal, a cycle redundancy check (CRC) error will occur, such that the effective fast information channel (FIC) and fast information block (FIB) cannot be successfully obtained. In this case, the control module 330 proceeds to a next channel for execution of the ensemble auto searching (step S430).

After execution of step S410 to step S470, step S475 is executed to inspect whether the searching over the entire band of the DAB system is finished. If not, the control module 330 then proceeds to a next channel for execution of the ensemble auto searching (step S430). If yes, the entire flowchart of the ensemble auto searching ends.

In another embodiment of the present invention, the first correlation value between the first phase reference symbol and the preset phase reference symbol that is calculated by the control module 330 can further be used to determine the received signal quality. The control module 330 obtains a mapping value by mapping the first correlation value to signal quality criteria and determines the current signal quality of the first channel based on the mapping value. The signal quality criteria are stored in the storage unit 320 for the control module 330 to use.

In summary, the prevent invention provides a method and device for improving ensemble auto searching efficiency by taking advantage of characteristics of the phase reference symbol. In embodiments of the present invention, the correlation value between the phase reference symbol of the received DAB transmitted signal and a preset phase reference symbol is calculated for further screening out valid DAB channels. This reduces the possibility of misjudgment of validity of a DAB channel which would happen when only the mechanism of determining whether the time interval of the null symbols fits a preset transmitted frame is used. As can be seen from the sharp contrast between the correlation values of FIG. 5A and FIG. 5B, if this channel is an invalid DAB channel (see FIG. 5B), the calculated correlation value will be very small. That is, the falsely identified DAB channel can be filtered out by considering the correlation value between the phase reference symbol of the received DAB transmitted signal and a preset phase reference symbol. Collecting the digital content service information in the channel is very time-consuming. The present invention can effectively filter out the falsely identified DAB channel before collecting the digital content service information in the channel. Therefore, the present invention can effectively avoid waste of time due to misjudgment during ensemble auto searching, thus reducing the time for ensemble auto searching.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for improving ensemble auto searching efficiency, adapted for ensemble auto searching of a digital audio broadcasting system, comprising:
receiving a first digital audio broadcasting transmitted signal;
calculating a time interval between null symbols of adjacent ones of multiple continuous transmitted frames in the first digital audio broadcasting transmitted signal;
if the time interval fits a preset transmitted frame time duration, determining a first channel corresponding to the first digital audio broadcasting transmitted signal to be a preliminarily identified digital audio broadcasting channel;
detecting a first phase reference symbol of the first digital audio broadcasting transmitted signal;
calculating a first correlation value between the first phase reference symbol and a preset phase reference symbol; and
if the first correlation value is greater than or equal to a threshold, determining the first channel to be a valid digital audio broadcasting channel.

2. The method for improving ensemble auto searching efficiency according to claim 1, further comprising:
if the time interval does not fit the preset transmitted frame time duration, determining the first channel corresponding to the first digital audio broadcasting transmitted signal to be an invalid digital audio broadcasting channel; and
proceeding to a next channel for execution of the ensemble auto searching.

3. The method for improving ensemble auto searching efficiency according to claim 1, wherein, if the correlation value between the first phase reference symbol and the preset phase reference symbol calculated with respect to each carrier frequency offset is different, the highest correlation value is selected as the first correlation value.

4. The method for improving ensemble auto searching efficiency according to claim 1, further comprising using the first correlation value for frequency synchronization and phase synchronization of the ensemble auto searching.

5. The method for improving ensemble auto searching efficiency according to claim 1, further comprising:
if the first correlation value is less than the threshold, determining the first channel corresponding to the first digital audio broadcasting transmitted signal to be an invalid digital audio broadcasting channel; and
proceeding to a next channel for execution of the ensemble auto searching.

6. The method for improving ensemble auto searching efficiency according to claim 1, further comprising collecting digital content service information in the first channel after determining the first channel corresponding to the first digital audio broadcasting transmitted signal to be a valid digital audio broadcasting channel.

7. The method for improving ensemble auto searching efficiency according to claim 6, wherein when the collected amount of digital content service information in the first channel has reached a desired amount, the digital content service information is stored.

8. The method for improving ensemble auto searching efficiency according to claim 6, when the collected amount of digital content service information in the first channel does not reach a desired amount within a predetermined time limit, proceeding to a next channel for execution of the ensemble auto searching.

9. The method for improving ensemble auto searching efficiency according to claim 1, further comprising obtaining a mapping value by mapping the first correlation value to signal quality criteria and determining the current signal quality of the first channel based on the mapping value.

10. A device for improving ensemble auto searching efficiency, adapted for ensemble auto searching of a digital audio broadcasting system, comprising:
a transceiver module for receiving a first digital audio broadcasting transmitted signal;
a storage unit for providing a storage space for storing a preset transmitted frame time duration, a preset phase reference symbol and a threshold; and
a control module coupled to the transceiver module and the storage unit for calculating a time interval between null symbols of adjacent ones of multiple continuous transmitted frames in the first digital audio broadcasting transmitted signal, wherein
if the time interval fits the preset transmitted frame time duration, the control module determines a first channel corresponding to the first digital audio broadcasting transmitted signal to be a preliminarily identified digital audio broadcasting channel; the control module then detects a first phase reference symbol of the first digital audio broadcasting transmitted signal; the control module calculates a first correlation value between the first phase reference symbol and the preset phase reference symbol; if the first correlation value is greater than or equal to a threshold, the control module determines the first channel to be a valid digital audio broadcasting channel.

11. The device for improving ensemble auto searching efficiency according to claim 10, if the time interval does not fit the preset transmitted frame time duration, the control module determines the first channel corresponding to the first digital audio broadcasting transmitted signal to be an invalid digital audio broadcasting channel; and the control module then proceeds to a next channel for execution of the ensemble auto searching.

12. The device for improving ensemble auto searching efficiency according to claim 10, if the correlation value between the first phase reference symbol and the preset phase reference symbol calculated with respect to each carrier frequency offset is different, the highest correlation value is selected as the first correlation value.

13. The device for improving ensemble auto searching efficiency according to claim 10, further comprising that the control module uses the first correlation value for frequency synchronization and phase synchronization of the ensemble auto searching.

14. The device for improving ensemble auto searching efficiency according to claim 10, further comprising that, if the first correlation value is less than the threshold, the control module determines the first channel corresponding to the first digital audio broadcasting transmitted signal to be an invalid digital audio broadcasting channel; and the control module then proceeds to a next channel for execution of the ensemble auto searching.

15. The device for improving ensemble auto searching efficiency according to claim 10, further comprising that the control module collects digital content service information in the first channel after determining the first channel corresponding to the first digital audio broadcasting transmitted signal to be a valid digital audio broadcasting channel.

16. The device for improving ensemble auto searching efficiency according to claim 15, wherein when the collected amount of digital content service information in the first channel has reached a desired amount, the control module stores the digital content service information into the storage unit.

17. The device for improving ensemble auto searching efficiency according to claim 10, wherein when the amount of digital content service information in the first channel that is collected by the control module does not reach a desired amount within a predetermined time limit, the control module proceeds to a next channel for execution of the ensemble auto searching.

18. The device for improving ensemble auto searching efficiency according to claim 10, further comprising that the control module obtains a mapping value by mapping the first correlation value to signal quality criteria and determines the current signal quality of the first channel based on the mapping value, wherein the signal quality criteria are stored in the storage unit.
